(19) United States
(12) Patent Application Publication
(10) Pub. No.: US 2023/0145491 A1
(43) Pub. Date: May 11, 2023

(54) SCREWDRIVER STRUCTURE

(71) Applicants: Jin-Tsai Lai, Taichung City (TW); Chia-Wei Lai, Taichung City (TW)

(72) Inventors: Jin-Tsai Lai, Taichung City (TW); Chia-Wei Lai, Taichung City (TW)

(73) Assignee: WEI CHINS PLASTIC ENTERPRISE CORP., Taichung City (TW)

(21) Appl. No.: 17/524,159

(22) Filed: Nov. 11, 2021

(51) Int. Cl. B25B 23/00; B25B 15/02

(52) U.S. Cl. CPC B25B 23/0035; B25B 15/02

(57) ABSTRACT

A screwdriver structure may include a tool rod and a rotating head which are adapted to connect together, and the tool rod is configured to be connected with a handle when the rotating head is separated from the tool rod, so as to use the screwdriver for different situations. The tool rod has a hand-holdable main body which has one end connecting to an extending rod, and a connecting column formed at the other end of the main body has the outer diameter smaller than the main body, and at least a flange is formed on the outer periphery of the connecting column. The extending rod comprises a sleeve at the end thereof to connect a tool head or a bolt.

### FIELD OF THE INVENTION

The present invention relates to a screwdriver structure and more particularly to a screwdriver having a tool rod that can be used alone.

### BACKGROUND OF THE INVENTION

According to the screwdriver disclosed in Taiwan Patent Publication No. 1338608, the conventional screwdriver structure comprises a handle (1), a base (2), and a control unit (3). The handle (1) is connected to the base (2), and the base (2) is configured to connect to and secure one of different tool rods (4). The base (2) has an accommodating portion (224) which is provided to receive the control unit (3), and at least an abutting portion (225), and the control unit (3) comprises at least a securing portion (32) which is adapted to partially contact the abutting portion (225). Moreover, the securing portion (32) has an end to extendedly insert into and secure the tool rod (4). Thus, when the control unit (3) is pressed, the end the securing portion (32) which is abutted against the abutting portion (225) is provided as the support point to make the other end tilt up so as to separate from the tool rod (4), thereby changing the tool rod (4).

However, the conventional screwdriver has following disadvantages: (i) the tool rod (4) can only be used together with the handle (1), so as to significantly lower the practicability. Therefore, there remains a need for a new and improved design for a screwdriver structure to overcome the problems presented above.

### SUMMARY OF THE INVENTION

The present invention provides a screwdriver structure comprising a tool rod and a rotating head which are adapted to connect together, and when separated from the rotating head, the tool rod configured to be connected with a handle, so as to use the screwdriver for different situations, so as to use the screwdriver for different situations. The tool rod has a hand-holdable main body which has one end connecting to an extending rod, and a connecting column formed at the other end of the main body has the outer diameter smaller than the main body, and at least a flange is formed on the outer periphery of the connecting column. The extending rod comprises a sleeve at the end thereof to connect a tool head or a bolt. The main body of the tool rod is an insulated body, and the main body has a shaft, and an engaging groove is formed on the shaft adjacent to the extending rod. The engaging groove is provided to engage and disengage the handle with the main body in pressing method when the engaging groove of the main body is connected and disconnected to the handle. The rotating head comprises a connecting end and a contact end, and the connecting end has an axial connecting hole at the center thereof and extending axially toward the contact end. At least a peripheral locating groove is formed on the inner periphery of the connecting hole, and the flange is configured to couple in the locating groove when the connecting column of the tool rod is connected into the connecting hole of the rotating head, so as to secure the connection between the rotating head and the tool rod, such that through connecting with the rotating head, the tool rod is adapted to be used without connecting to the handle.

Comparing with conventional screwdriver structure, the present invention is advantageous because: the tool rod can directly be connected to the rotating head for use, and when the rotating head is detached from the tool rod, the tool rod can be connected to the handle for use, so as to significantly improve the practicability of the tool rod.

### BRIEF DESCRIPTION OF THE DRAWINGS

FIG. 1 is a three-dimensional assembly view of a screwdriver structure of the present invention.

FIG. 2 is a three-dimensional exploded view of the screwdriver structure of the present invention.

FIG. 3 is a schematic view illustrating a tool rod of the screwdriver structure is separated with a rotating head and is connected with a handle in the present invention.

FIG. 4 is a schematic view illustrating the tool rod of the screwdriver structure is directly connected to the rotating head for use in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

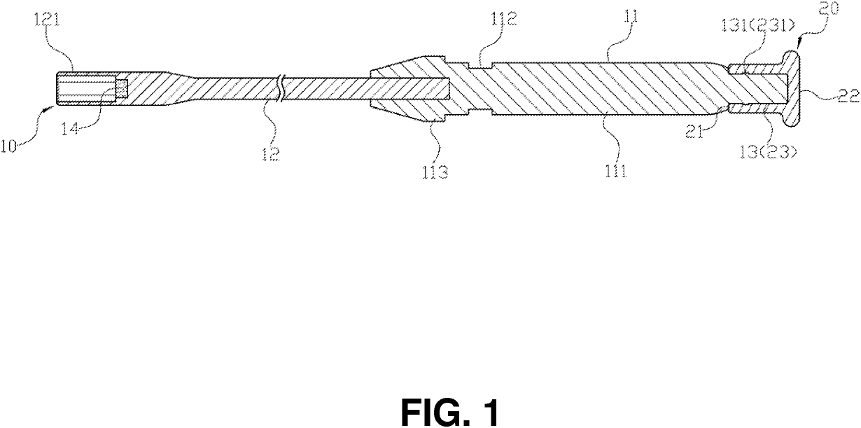

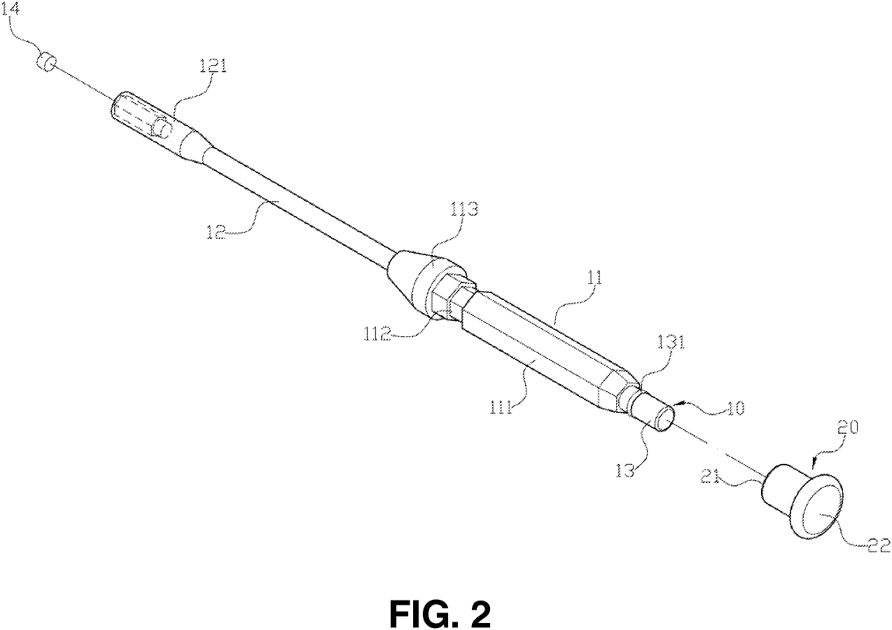

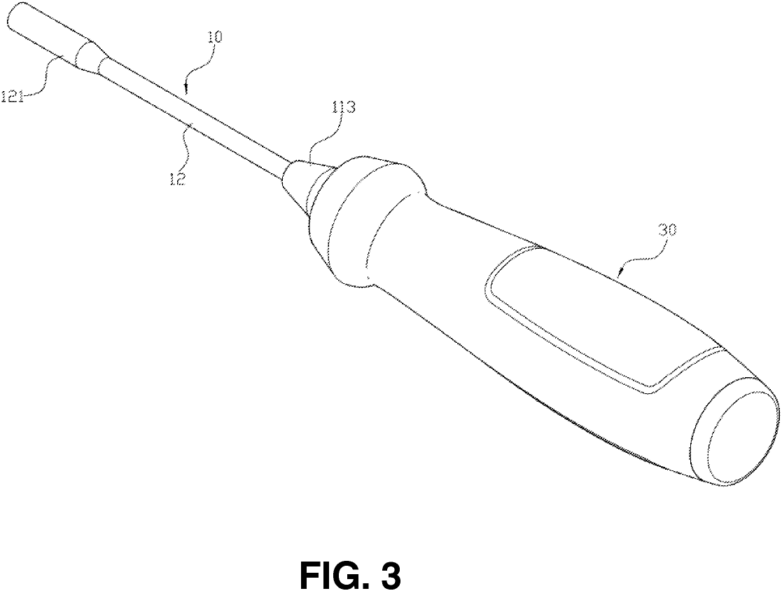

Referring to FIGS. 1 and 2, the present invention provides a screwdriver structure comprising a tool rod (10) and a rotating head (20) which are adapted to connect together, and the tool rod (10) is configured to be connected with a handle (30) when the rotating head (20) is separated from the tool rod (10) (as shown in FIG. 3), so as to use the screwdriver for different situations. The tool rod (10) has a hand-holdable main body (11) which has one end connecting to an extending rod (12), and a connecting column (13) formed at the other end of the main body (11) has the outer diameter smaller than the main body (11). Moreover, at least a flange (131) is formed on the outer periphery of the connecting column (13). The extending rod (12) comprises a sleeve (121) at the end thereof to connect a tool head (40) or a bolt. The main body (11) of the tool rod (10) is an insulated body, and the main body (11) has a shaft (111), and an engaging groove (112) is formed on the shaft (111) adjacent to the extending rod (12). The engaging groove (112) is provided to engage and disengage the handle (30) with the main body (11) in pressing method when the engaging groove (112) of the main body (11) is connected and disconnected to the handle (30). The rotating head (20) comprises a connecting end (21) and a contact end (22), and the connecting end (21) has an axial connecting hole (23) at the center thereof and extending axially toward the contact end (22). At least a peripheral locating groove (231) is formed on the inner periphery of the connecting hole (23), and the flange (131) is configured to couple in the locating groove (231) when the connecting column (13) of the tool rod (10) is connected into the connecting hole (23) of the rotating head (20), so as to secure the connection between the rotating head (20) and the tool rod (10), such that through connecting with the rotating head (20), the tool rod (10) is adapted to be used without connecting to the handle (30).

In one embodiment, the shaft (111) of the main body (11) has a hexagonal cross section.

In another embodiment, the shaft (111) of the main body (11) comprises an axial tapered cylindrical blocking portion (113) at the end of the shaft (111) connecting to the extending rod (12).

In still another embodiment, the extending rod (12) is made of metal, and the metallic extending rod is coated with an insulation layer to achieve the insulting effect.

In a further embodiment, a magnetic piece (14) is positioned in the sleeve (121) of the tool rod (10).

In still a further embodiment, a positioning ball is installed in the sleeve (121) of the tool rod (10) for positioning purpose (not shown in FIGs.).

In an advantageous embodiment, a C-ring is installed in the sleeve (121) of the tool rod (10) for engaging purpose (not shown in FIGs.).

In a preferred embodiment, the rotating head (20) is shaped in stepped shape.

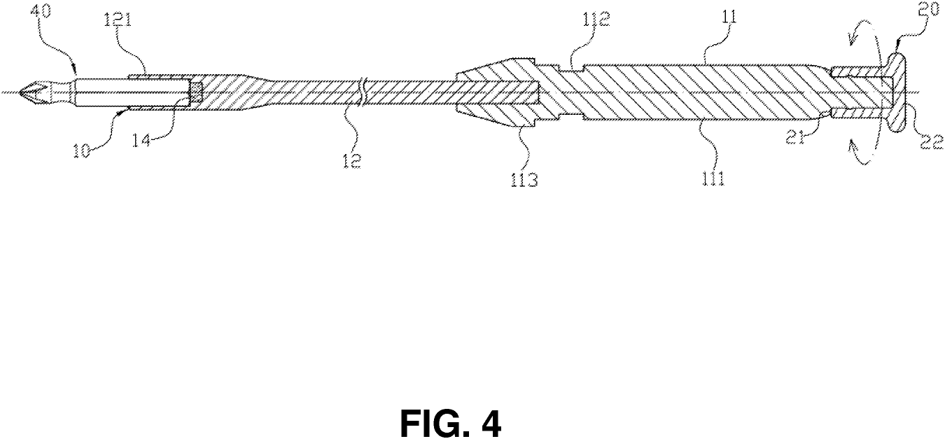

In actual application, the tool rod (10) can directly be connected to the rotating head (20) for use, and when the rotating head (20) is detached from the tool rod (10), the tool rod (10) can be connected to the handle (30) for use, so as to significantly improve the practicability of the tool rod (10). Moreover, the tool rod (10) with the rotating head (20) can be used when one of the tool heads (40) or bolts is directly coupled in the sleeve (121) of the extending rod (12), and the tool head (40) can be driven by the tool rod (10), and the user can push the contact end (22) of the rotating head (20) to enable the tool head (40) be driven stably (as shown in FIG. 4).

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A screwdriver structure comprising a tool rod and a rotating head which are adapted to connect together, and when separated from the rotating head, the tool rod configured to be connected with a handle, so as to use the screwdriver for different situations;
wherein the tool rod has a hand-holdable main body which has one end connecting to an extending rod, and a connecting column formed at the other end of the main body has the outer diameter smaller than the main body, and at least a flange is formed on the outer periphery of the connecting column; the extending rod comprises a sleeve at the end thereof to connect a tool head or a bolt; the main body of the tool rod is an insulated body, and the main body has a shaft, and an engaging groove is formed on the shaft adjacent to the extending rod; the engaging groove is provided to engage and disengage the handle with the main body in pressing method when the engaging groove of the main body is connected and disconnected to the handle; and
wherein rotating head comprises a connecting end and a contact end, and the connecting end has an axial connecting hole at the center thereof and extending axially toward the contact end; at least a peripheral locating groove is formed on the inner periphery of the connecting hole, and the flange is configured to couple in the locating groove when the connecting column of the tool rod is connected into the connecting hole of the rotating head, so as to secure the connection between the rotating head and the tool rod, such that through connecting with the rotating head, the tool rod is adapted to be used without connecting to the handle.

2. The screwdriver structure of claim 1, wherein the shaft of the main body has a hexagonal cross section.

3. The screwdriver structure of claim 1, wherein the shaft of the main body comprises an axial tapered cylindrical blocking portion at the end of the shaft connecting to the extending rod.

4. The screwdriver structure of claim 1, wherein the extending rod is made of metal.

5. The screwdriver structure of claim 1, wherein the extending rod is made of metal, and the metallic extending rod is coated with an insulation layer to achieve the insulting effect.

6. The screwdriver structure of claim 1, wherein a magnetic piece is positioned in the sleeve of the tool rod.

7. The screwdriver structure of claim 1, wherein a positioning ball is installed in the sleeve of the tool rod for positioning purpose.

8. The screwdriver structure of claim 1, wherein a C-ring is installed in the sleeve of the tool rod for engaging purpose.
